(19) United States
(12) Patent Application Publication
(10) Pub. No.: US 2011/0198172 A1
(43) Pub. Date: Aug. 18, 2011

(54) DAMPING FORCE VARIABLE VALVE OF A SHOCK ABSORBER

(76) Inventor: Jee Young WHAN, Gyeonggi-do (KR)

(21) Appl. No.: 13/028,729

(22) Filed: Feb. 16, 2011

(30) Foreign Application Priority Data
Feb. 16, 2010 (KR) 10-2010-0013702

(51) Int. Cl. F16F 9/34

(52) U.S. Cl. 188/322.13

(57) ABSTRACT

Provided is a damping force variable valve of a shock absorber. The damping force variable valve of the shock absorber includes: a retainer formed with an inflow passage into which a working fluid is introduced from the shock absorber; a valve body disposed behind the retainer; an elastic member pressurizing the valve body in a direction of stopping the inflow passage, behind the valve body; a spool guide formed with a back pressure control passage inducing some of the working fluid in front of the valve body into a back pressure chamber behind the valve body; and a spool moving forward and backward according a change in current of a solenoid to control an opening of the back pressure control passage, wherein the valve body moves backward from a position where the inflow passage stops to form a discharge passage between the valve body and the retainer, and the size of the discharge passage varies by the pressure of the working fluid to control the discharge extent of the working fluid.

By this configuration, the valve body pressurized by the elastic member vertically moves according to the pressure and back pressure of the working fluid to open the discharge passage of the working fluid, such that the damping force of the damping force variable valve may be easily varied according to the pressure of the working fluid, thereby making it possible to obtain the desired damping force characteristics of the damping force variable valve.

### CROSS-REFERENCE TO RELATED APPLICATIONS

This application claims priority from and the benefit of Korean Patent Application No. 2010-0013702, filed on Feb. 16, 2010, which are hereby incorporated by reference for all purposes as if fully set forth herein.

### BACKGROUND OF THE INVENTION

1. Field of the Invention

The present invention relates to a damping force variable valve of a shock absorber.

2. Discussion of the Background

Generally, a shock absorber, which is mounted on a mobile device such as a vehicle, improves rideness by absorbing and buffering vibrations, impacts, etc., from a road surface caused when driving.

The shock absorber is configured to include a cylinder and a piston rod compressibly and extensibly mounted in the cylinder. The cylinder and the piston rod are each mounted on a car body, wheels, or an axle.

Among the shock absorber, a shock absorber having a low damping force absorbs vibrations due to ruggedness on a road surface when driving, thereby making it possible to improve rideness. On the other hand, the shock absorber having a high damping force suppresses a change in posture of a car body to improve handling stability.

Recently, a damping force variable shock absorber capable of appropriately controlling damping force characteristics in order to improve rideness or handling stability according to a road surface, a driving state, etc. by mounting a damping force variable valve capable of appropriately controlling damping force characteristics on one side of the shock absorber has been developed.

FIG. 1 is a cross-sectional view showing a damping force variable shock absorber according to the related art.

A damping force variable shock absorber 10 according to the related art is configured to include a base shell 12 and the inner tube 14 mounted in the base shell 12. The top end and the bottom end of the inner tube 14 and the base shell 12 are each mounted with a rod guide 26 and a body valve 27. Further, the piston rod 24 is slidably supported up and down by the rod guide 26 and one end of the piston rod 24 in the inner tube 14 is coupled with the piston valve 25. The piston valve 25 partitions the inner space of the inner tube 14 into a rebound chamber 20 and a compression chamber 22. The top portion and the bottom portion of the base shell 12 are each mounted with a top cap 28 and a base cap 29.

A reservoir chamber 30 compensating for a volume change in the inner tube 14 due to a reciprocating motion of the piston rod 24 is formed between the inner tube 14 and the base shell 12. The flow of a working fluid between the reservoir chamber 30 and the compression chamber 22 is controlled by the body valve 27.

In addition, a separator tube 16 is mounted inside the base shell 12. The inside of the base shell 12 is partitioned into a high pressure chamber PH connected with the rebound chamber 20 and a low pressure chamber PL as a reservoir chamber 30 by the separator tube 16.

The high pressure chamber PH is connected with the rebound chamber 20 through a hole 14a formed in the inner tube 14. Meanwhile, the low pressure chamber PL is connected with a compression chamber 22 through a lower passage 32 formed between a body part of the body valve 27 and the base shell 12.

One side of the base shell 12 is mounted with a damping force variable valve 40 in order to appropriately control the damping force characteristics according to the road surface, the driving state, etc.

FIG. 2 is a cross-sectional view showing a damping force variable valve attached to the damping force variable shock absorber according to the related art.

The damping force variable valve 40 is formed with an oil passage that is connected with the base shell 12 and the separator tube 16, respectively, and communicates with the high pressure chamber PH and the low pressure chamber PL, respectively. In addition, the damping force variable valve 40 is mounted with a spool 44 moved by the driving of the actuator 42. The damping force variable valve 40 varies the damping force of the shock absorber 10 while the inner passage communicating with the high pressure chamber PH and the low pressure chamber PL varies due to the movement of the spool 44.

The inside of the damping force variable valve 40 is provided with a disk valve 50 and a back pressure chamber 60 used to vary the damping force of the shock absorber. The back pressure chamber 60 is prepared to provide a back pressure pressurizing the disk valve 50, behind the disk valve 50.

The disk valve 50 is mounted to cover a passage 51a vertically formed to a retainer 51, behind the retainer 51. Meanwhile, the retainer 51 is connected with the high pressure chamber PH of the above-mentioned shock absorber by a connector 40a. Therefore, the high-pressure working fluid introduced through the connector 40a from the high pressure chamber PH flows toward the disk valve 50, passing through the passage 51a.

The damping force variable valve 40 includes the actuator 42 of which the moving distance is changed according to a current value applied to a solenoid 41. In addition, the damping force variable valve 40 includes a spool 44 that is disposed on the same shaft line as the actuator 42 to linearly move in connection with the actuator 42. The spool 44 is moved along a spool guide 45 and one end thereof contacts the actuator 42 and the other end thereof is elastically supported by a compression spring 46. The spool 44 moves forward by the pressure of the actuator 42 and moves backward by the restoring force of the compression spring 46.

The opening and closing and/or the opening and closing extent of the back pressure control passage 47 connected from the upstream side of the disk valve 50 to the back pressure chamber 60 is controlled by the interconnection between the spool 44 and the spool guide 45 due to the movement of the spool 44 according to the driving of the solenoid.

A ring member 61 disposed in the back pressure chamber 60 limits the flow of the working fluid toward the low pressure chamber PL to form the back pressure in the back pressure chamber 60. The ring member 61 is pressurized by the pressing disk 62 to limit the flow of the working fluid toward the surroundings of the ring member 61. The pressing disk 62 pressurizes the ring member 61 with a considerable pressure to form the back pressure in the back pressure chamber 60.

In the damping force variable valve 40 according to the related art, the disk valve 50 is formed by stacking a plurality of disks to cover the passage 51a vertically formed in the retainer 51. In addition, the disk valve 50 is pressurized even by the pressing disk 62 positioned at the bottom portion thereof.

The opening extent of the disk in the disk valve 50 is controlled by the change in pressure of the working fluid through the passage 51a and the change in back pressure of the disk valve 50 in the back pressure chamber 60 and the damping force is varied accordingly.

When the speed of the piston rod is increased, the pressure of the working fluid introduced into the damping force variable valve 40 is also increased and the damping force of the shock absorber is increased accordingly. In this case, in order to improve the rideness, it is preferable to set a slope, at which the damping force is increased, to be small through the damping force variable valve 40. To this end, as the pressure of the working fluid introduced into the damping force variable valve 40 is increased, a larger amount of working fluid is discharged through the disk valve 50 and the slope at which the damping force is increased becomes small. The characteristic of the damping force variable valve 40 is referred to as a degressive characteristic.

However, the damping force variable valve 40 according to the related art has a structure where the inner end of the disk valve 50 is fixed and only the outer end thereof is opened by the pressure of the working fluid. In addition, since the disk valve 50 in which the plurality of disks are stacked has strong stiffness and is pressurized by the pressing disk 62, even though the pressure of the working fluid is increased through the passage 51a, the opening extent of the outer end of the disk valve 50 is small, such that the amount of working fluid discharged through the disk valve 50 is not sufficiently increased. This degrades the rideness by increasing the damping force when the piston rod moves at high speed.

### SUMMARY OF THE INVENTION

The present invention provides a damping force variable valve of a shock absorber capable of preventing a damping force from suddenly increasing in order to improve rideness, by discharging a larger amount of working fluid as the pressure of the working fluid introduced into the damping force variable valve is increased due to the increased speed of a piston rod of a shock absorber.

An exemplary embodiment of the present invention provides a damping force variable valve of a shock absorber, including: a retainer formed with an inflow passage into which a working fluid is introduced from the shock absorber; a valve body disposed behind the retainer; an elastic member pressurizing the valve body in a direction of stopping the inflow passage, behind the valve body; a spool guide formed with a back pressure inducing some of the working fluid in front of the valve body into a back pressure chamber behind the valve body; and a spool moving forward and backward according a change in current of a solenoid to control an opening of the back pressure control passage, wherein the valve body moves backward from a position where the inflow passage stops to form a discharge passage between the valve body and the retainer, and the size of the discharge passage varies by the pressure of the working fluid to control the discharge extent of the working fluid.

The damping force variable valve of a shock absorber may further include a retainer disk disposed between the retainer and the valve body, wherein the retainer disk has a shape permitting the flow of the working fluid in the back pressure control passage.

The surface of the retainer may be formed with a slit and the slit may be formed inwardly toward the inner circumferential portion of the retainer disk to communicate with the back pressure control passage.

The damping force variable valve of a shock absorber may further include an inner ring member disposed between the valve body and the elastic member to partition the inner side of the back pressure chamber.

The movement of the inner ring member may be limited by a step formed in the spool guide or a step formed in the valve body.

The damping force variable valve of a shock absorber may further include an outer ring member disposed between the valve body and the elastic member to partition the outer side of the back pressure chamber.

The movement of the outer ring member may be limited by a step formed in the valve body.

The damping force variable valve of a shock absorber may further include: an inner ring member disposed between the valve body and the first spring to partition the inner side of the back pressure chamber; and an outer ring member disposed between the valve body and the second spring to partition the outer side of the back pressure chamber, wherein the elastic member includes a first spring and a second spring.

The movement of the inner ring member may be limited by the step formed in the spool guide, and the movement of the outer ring member may be limited by a step formed in the valve body.

The first spring and the second spring may have different elastic moduli.

Another exemplary embodiment of the present invention provides a damping force variable valve of a shock absorber, including: a retainer formed with an inflow passage; a valve body disposed behind the retainer to selectively stop the inflow passage; a back pressure chamber formed behind the valve body; and an elastic member pressurizing the valve body to the retainer, behind the valve body, wherein the valve body moves backward from a position where the inflow passage stops to form a discharge passage connected with the inflow passage, and the size of the discharge passage varies by the pressure of the working fluid passing through the inflow passage.

The discharge passage may be disposed at the outer circumferential portion of the valve body and the valve body may be configured to permit the flow of the working fluid in a back pressure control passage connected with the back pressure chamber from the front inner circumferential portion of the valve body.

The back pressure control passage may be formed in a spool guide penetrating through the valve body and the hollow of the spool guide is mounted with the spool to move forward and backward according to a change in current of a solenoid and may control an opening of the back pressure control passage by the front and back movement of the spool.

The inner ring member may stop one side of the back pressure chamber while contacting the rear inner circumferential portion of the valve body, the outer ring member may stop the other side of the back pressure chamber while contacting the rear outer circumferential portion of the valve body, and the elastic member may include a first spring and a second spring mounted to pressurize the inner ring member and the outer ring member.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a cross-sectional view showing an example of a damping force variable shock absorber according to the related art;

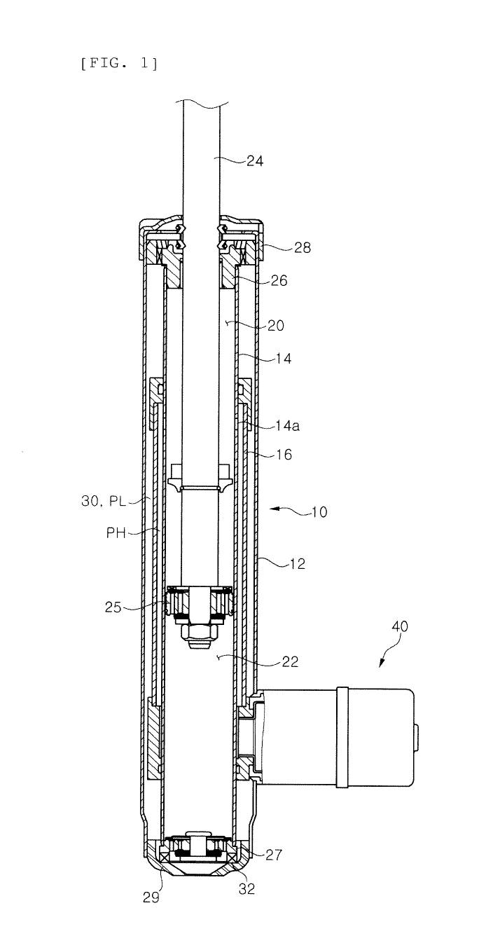

FIG. 2 is a cross-sectional view showing a damping force variable valve attached to the damping force variable shock absorber according to the related art;

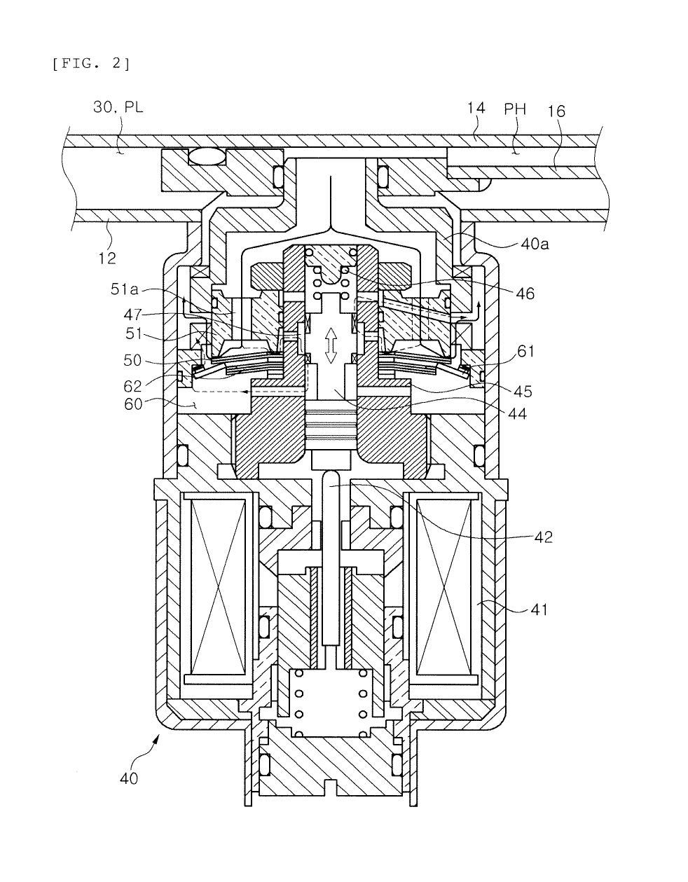

FIG. 3 is a cross-sectional view showing the damping force variable valve of the shock absorber according to the present invention; and

FIG. 4 is a graph showing the damping force of the shock absorber of the related art and the present invention according to the speed of the piston rod.

### DETAILED DESCRIPTION OF THE ILLUSTRATED EMBODIMENTS

Hereinafter, the configurations and operations of exemplary embodiments of the present invention will be described with reference to the accompanying drawings. In describing reference numerals for components in each drawing, although same components are illustrated in different drawings, they should be construed as being indicated by the same reference numerals, if possible.

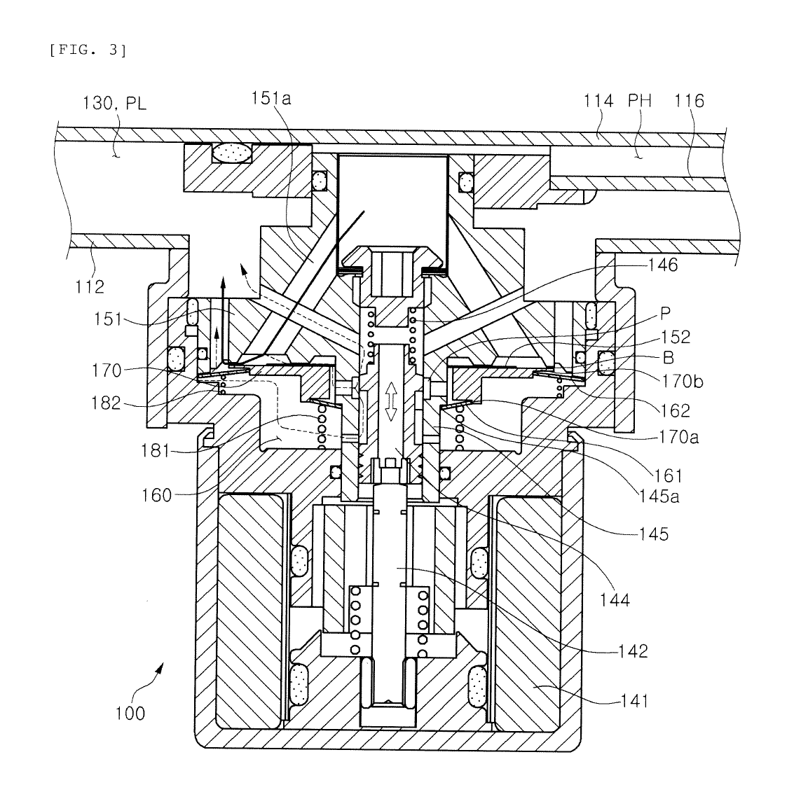

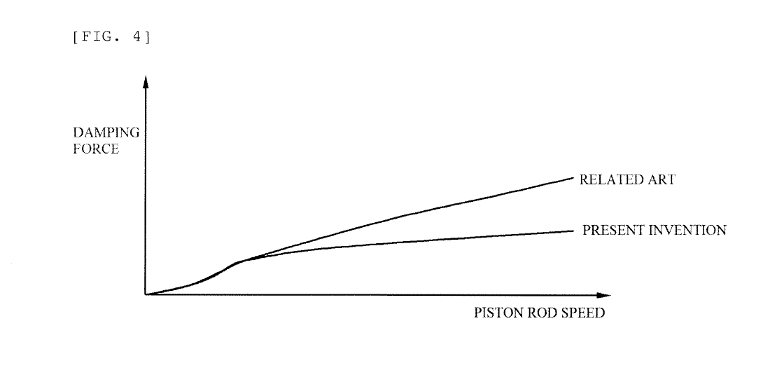

FIG. 3 is a cross-sectional view showing the damping force variable valve of the shock absorber according to the present invention. FIG. 4 is a graph showing the damping force of the shock absorber of the related art and the present invention according to the speed of the piston rod.

As shown in FIG. 3, the damping force variable valve 100 according to the exemplary embodiment of the present invention is provided with an oil passage that is connected with the base shell 112 and the separator tube 116, respectively, and communicates with the high pressure chamber PH and the low pressure chamber PL, respectively.

The damping force variable valve 100 includes a retainer 151 formed with an inflow passage 151a for the introduction of the working fluid from the shock absorber.

A valve body 170 is disposed behind the retainer 151 to selectively stop the inflow passage 151a. To this end, the valve body 170 is mounted to apply pressure to the retainer 151 in a direction that elastic members 181 and 182 stop the inflow passage 151a. When the pressure of the working fluid passing through the inflow passage 151a is larger than the elastic force of elastic members 181 and 182, the valve body 170 moves downwardly to open a discharge passage B formed between the outer circumferential portion of the retainer 151 and the valve body 170, thereby discharging the working fluid through the discharge passage B.

The retainer disk 152 is disposed between the retainer 151 and the valve body 170. A slit is formed on the surface of the retainer disk 152 to face the inner side of the retainer disk 152 in order to induce the working fluid to the inner side thereof. The working fluid introduced through the inflow passage 151 of the retainer 151 may flow to the back pressure control passage P through the slit formed on the retainer disk 152, even though the discharge passage B is not opened since the valve body 170 does not move backward.

The working fluid introduced through the inflow passage 151a from the high pressure chamber PH may flow into the back pressure chamber 160 along the back pressure control passage P.

The back pressure chamber 160 is provided with an inner ring member 161 partitioning the inner side of the back pressure chamber and the outer ring member 162 partitioning the outer side of the back pressure chamber. The inner ring member 161 and the outer ring member 162 limits the flow of the working fluid introduced into the back pressure chamber 160 to form the back pressure in the back pressure chamber 160.

The movement of the inner ring member 161 is limited by a step 145a formed in the spool guide 145 and a step 170a formed on the bottom portion of the valve body 170. The movement of the outer ring member 162 is limited by a step 170b formed on the side portion of the valve body 170.

The inner ring member 161 stops one side of the back pressure chamber 160 while contacting the rear inner circumferential portion of the valve body 170 and the outer ring member 162 stops the other side of the back pressure chamber 160 while contacting the rear outer circumferential portion of the valve body 170. The bottom portion of the inner ring member 161, that is, the rear thereof is mounted with a first spring 181 to pressurize the valve body 170 thereover through the inner ring member 161 and the bottom portion of the outer ring member 162, that is, the rear thereof is mounted with a second spring 182 to pressurize the valve body 170 thereover through the outer ring member 162.

Therefore, the inner ring member 161 and the valve body 170 are pressurized by the first spring 181 and the outer ring member 162 and the valve body 170 is pressurized by the second spring 182. The first spring 181 and the second spring 182 may have different elastic moduli.

The flow of the working fluid flowing in the back pressure chamber 160 along the back pressure control passage P is limited by the inner ring member 161 and the outer ring member 162 to serve as the back pressure pressurizing the valve body 170 to the retainer 151 side. As shown by a dotted arrow, some of the working fluid flowing in the back pressure chamber 160 may flow in the low pressure chamber PL through the outer ring member 162.

The opening and/or the opening degree of the back pressure control passage P are controlled by the movement of the spool 144. One end of the spool 144 contacts the actuator 142 of which the moving distance is changed according to a current value applied to the solenoid 141 and the other end of the spool 144 is elastically supported by the compression spring 146.

The spool 144 is linearly moved in connection with the actuator 142 and controls the opening and closing extent of the back pressure control passage P formed by the retainer 151, the spool guide 145, and the spool 144. In FIG. 3, the back pressure control passage P is formed by the retainer 151, the spool guide 145, and the spool 144, but as long as the working fluid is movable to the back pressure chamber 160 through the back pressure control passage, the back pressure control passage may be formed even by other components having a similar configuration to the above description.

When the spool 144 moves downward or backward to stop the passage connected with the back pressure chamber 160, the working fluid does not flow through the back pressure chamber 160 and as shown by a dotted line, flows to the low pressure chamber PL through the top portion of the back pressure control passage P. When the spool 144 moves upward or forward to open the passage connected with the back pressure chamber 160, the working fluid flows in the back pressure chamber 160 through the back pressure control passage P. The amount of working fluid flowing in the back pressure chamber 160 is controlled according to the position of the spool 144.

Hereinafter, a process of varying the damping force by controlling the discharged amount of working fluid introduced through the inflow passage 151a from the high pressure chamber PH will be described.

When the amount of working fluid introduced through the inflow passage 151a from the high pressure chamber PH is small, the working fluid is discharged through the slit formed in the retainer disk 152. The slit fluid-communicates with the back pressure control passage P, such that the working fluid is introduced into the back pressure chamber 160 or the low pressure chamber PL through the back pressure control passage P.

When the amount of working fluid introduced through the inflow passage 151a from the high pressure chamber PH is increased, the pressure of the working fluid overcomes the elastic force of the first and second springs 181 and 182 and pressurizes the valve body 170 downward, that is, backward. As the movement of the valve body 170, the discharge passage B formed between the end of the retainer 151 and the valve body 170 is opened. When the discharge passage B is opened, the working fluid may flow in the back pressure control passage P or the low pressure chamber PL. The larger the amount of working fluid discharged through the discharge passage B, the lower the damping force of the shock absorber becomes.

The opening and/or the opening degree of the back pressure control passage P are controlled by the movement of the spool 144.

When the spool 144 moves downward to close the passage connected with the back pressure chamber 160, the working fluid may not be introduced into the back pressure chamber 160, such that the back pressure in the back pressure chamber 160 is low. When the back pressure in the back pressure chamber 160 is low, the valve body 170 further moves downward, that is, backward by the pressure of the working fluid. Therefore, a larger amount of working fluid is discharged through the discharge passage B and the damping force is low accordingly.

When the spool 144 moves upward to open the passage connected with the back pressure chamber 160, the working fluid is introduced into the back pressure chamber 160 to be filled in the back pressure chamber 160. When the back pressure in the back pressure chamber 160 is increased, even though the pressure of the working fluid introduced through the inflow passage 151a is increased, it is difficult to move the valve body 170 downward. Therefore, the amount of working fluid discharged through the discharge passage B is reduced and the damping force is increased accordingly.

As described above, the valve body 170 vertically moves according to the pressure of the working fluid introduced through the inflow passage 151a of the retainer 151 and the back pressure of the working fluid introduced into the back pressure chamber 160 and the opening extent of the discharge passage B is varied accordingly, such that the discharge extent of the working fluid is controlled.

The valve body 170 vertically moves according to the change in pressure of the working fluid and the change in back pressure, such that the opening extent of the discharge passage B may be controlled according to the elastic modulus of the first and second springs 181 and 182 pressurizing the valve body 170.

For example, when the elastic modulus of the first and second springs 181 and 182 is small (when the same force is applied, the shrinkage distance of the spring is increased), the moving distance of the valve body 170 is increased according to the pressure of the working fluid to increase the opening width of the discharge passage B, such that the change degree of the damping force may be increased according to the pressure of the working fluid according to the speed of the piston rod. Therefore, it is possible to obtain the degressive characteristic of the damping force variable valve 100.

However, when the elastic modulus of the first and second springs 181 and 182 is large (when the same force is applied, the shrinkage distance of the spring is small), the opening width of the discharge passage B is small according to the pressure of the working fluid, such that the change extent of the damping force is small even though the speed of the piston rod is increased.

As described above, the exemplary embodiment of the present invention configures the valve body 170 in a spring press type and appropriately sets the elastic modulus coefficient of the first and second springs 181 and 182, thereby making it possible to freely obtain the desired damping force characteristics of the damping force variable valve 100.

Referring to FIG. 4, it can be appreciated that the increased degree of the damping force with the increased speed of the piston rod according to the exemplary embodiment of the present invention is smaller than that of the related art. This implies that the variable extent of the damping force by the damping force variable valve according to the present invention is further increased. The damping force characteristics reduce the damping force when the piston rod moves at high speed, thereby improving the rideness.

In addition, when the elastic modulus of the first spring 181 and the second spring 182 are set to be different from each other, the valve body 170 is opened in an inclined state to some degree, such that the amount of working fluid discharged through the discharge passages B at both sides of the inflow passage 151a may be controlled differently. For example, when the elastic modulus of the first spring 181 is set to be smaller than that of the second spring 182, the valve body 170 moves in the inclined state by the pressure of the working fluid so that the discharge passage B connected with the back pressure control passage P is further opened. Therefore, it is possible to increase the amount of working fluid flowing in the back pressure control passage P. This can more freely obtain the desired damping force characteristics of the damping force variable valve 100.

As described above, the damping force variable valve 100 according to the present invention is pressurized by the elastic members 181 and 182 and may vertically move according to the pressure of the working fluid introduced through the inflow passage 151a of the retainer 151. Therefore, the discharged amount of the working fluid through the discharge passage B may be freely controlled according to the pressure of the working fluid by controlling the elastic modulus the elastic member, for example, the spring.

In addition, the elastic modulus of the spring is designed to be low and thus, the damping force of the damping force variable valve is low when the piston rod moves at high speed, thereby making it possible to improve the rideness.

In addition, the elastic member is configured of the first spring 181 and the second spring 182 and the elastic modulus of the first spring 181 and the second spring 182 are designed to be different from each other, such that the discharged amount of the working fluid through the discharge passages B at both lower sides of the retainer 151 may be set differently. This can more freely and easily obtain the desired damping force characteristics of the damping force variable valve.

As set forth above, the exemplary embodiment of the present invention may open the discharge passage of the working fluid by vertically moving the valve body pressurized by the elastic member according to the pressure and back pressure of the working fluid and easily vary the damping force of the damping force variable valve according to the pressure of the working fluid by appropriately controlling the elastic force of the elastic member, thereby making it possible to provide the damping force variable valve of the shock absorber capable of obtaining the desired damping force characteristics

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A damping force variable valve of a shock absorber, comprising:
a retainer formed with an inflow passage into which a working fluid is introduced from the shock absorber;
a valve body disposed behind the retainer;
an elastic member pressurizing the valve body in a direction of stopping the inflow passage, behind the valve body;
a spool guide formed with a back pressure control passage inducing some of the working fluid in front of the valve body into a back pressure chamber behind the valve body; and
a spool moving forward and backward according a change in current of a solenoid to control an opening of the back pressure control passage,
wherein the valve body moves backward from a position where the inflow passage stops to form a discharge passage between the valve body and the retainer, and
the size of the discharge passage varies by the pressure of the working fluid to control the discharge extent of the working fluid.

2. The damping force variable valve of a shock absorber of claim 1, further comprising a retainer disk disposed between the retainer and the valve body, wherein the retainer disk has a shape permitting the flow of the working fluid in the back pressure control passage.

3. The damping force variable valve of a shock absorber of claim 2, wherein the surface of the retainer is formed with a slit and the slit is formed inwardly toward the inner circumferential portion of the retainer disk to communicate with the back pressure control passage.

4. The damping force variable valve of a shock absorber of claim 1, further comprising an inner ring member disposed between the valve body and the elastic member to partition the inner side of the back pressure chamber.

5. The damping force variable valve of a shock absorber of claim 4, wherein the movement of the inner ring member is limited by a step formed in the spool guide or a step formed in the valve body.

6. The damping force variable valve of a shock absorber of claim 1, further comprising an outer ring member disposed between the valve body and the elastic member to partition the outer side of the back pressure chamber.

7. The damping force variable valve of a shock absorber of claim 6, wherein the movement of the outer ring member is limited by a step formed in the valve body.

8. The damping force variable valve of a shock absorber of claim 1, further comprising:
an inner ring member disposed between the valve body and the first spring to partition the inner side of the back pressure chamber; and
an outer ring member disposed between the valve body and the second spring to partition the outer side of the back pressure chamber,
wherein the elastic member includes a first spring and a second spring.

9. The damping force variable valve of a shock absorber of claim 8, wherein the movement of the inner ring member is limited by the step formed in the spool guide, and
the movement of the outer ring member is limited by a step formed in the valve body.

10. The damping force variable valve of a shock absorber of claim 8 or 9, wherein the first spring and the second spring have different elastic moduli.

11. A damping force variable valve of a shock absorber, comprising:
a retainer formed with an inflow passage;
a valve body disposed behind the retainer to selectively stop the inflow passage;
a back pressure chamber formed behind the valve body; and
an elastic member pressurizing the valve body to the retainer, behind the valve body,
wherein the valve body moves backward from a position where the inflow passage stops to form a discharge passage connected with the inflow passage, and
the size of the discharge passage varies by the pressure of the working fluid passing through the inflow passage.

12. The damping force variable valve of a shock absorber of claim 11, wherein the discharge passage is disposed at the outer circumferential portion of the valve body and the valve body is configured to permit the flow of the working fluid in a back pressure control passage connected with the back pressure chamber from the front inner circumferential portion of the valve body.

13. The damping force variable valve of a shock absorber of claim 12, wherein the back pressure control passage is formed in a spool guide penetrating through the valve body and the hollow of the spool guide is mounted with the spool to move forward and backward according to a change in current of a solenoid and controls an opening of the back pressure control passage by the front and back movement of the spool.

14. The damping force variable valve of a shock absorber of claim 13, further comprising an inner ring member disposed between the valve body and the elastic member to partition the inner side of the back pressure chamber.

15. The damping force variable valve of a shock absorber of claim 14, wherein the movement of the inner ring member is limited by a step formed in the spool guide or a step formed in the valve body.

16. The damping force variable valve of a shock absorber of claim 13, further comprising an outer ring member disposed between the valve body and the elastic member to partition the outer side of the back pressure chamber.

17. The damping force variable valve of a shock absorber of claim 16, wherein the movement of the outer ring member is limited by a step formed in the valve body.

18. The damping force variable valve of a shock absorber of claim 11, wherein the inner ring member stops one side of the back pressure chamber while contacting the rear inner circumferential portion of the valve body, the outer ring member stops the other side of the back pressure chamber while contacting the rear outer circumferential portion of the valve body, and the elastic member includes a first spring and a second spring mounted to pressurize the inner ring member and the outer ring member.

19. The damping force variable valve of a shock absorber of claim 18, wherein the first spring and the second spring have different elastic moduli.
